(19) United States
(12) Patent Application Publication
(10) Pub. No.: US 2008/0008938 A1
(43) Pub. Date: Jan. 10, 2008

(54) Preparation and application of LiFePO4/Li3V2 (PO4)3 composite cathode materials for lithium ion batteries

(75) Inventors: She-Huang Wu, Taipei (TW); Mu-Rong Yang, Taipei (TW); Wei-Hsin Ke, Taipei (TW); Yuan-Lung Huang, Taipei (TW); Nien-Chieh Yu, Taipei (TW)

Correspondence Address: BACON & THOMAS, PLLC, 625 SLATERS LANE, FOURTH FLOOR, ALEXANDRIA, VA, 22314, US

(73) Assignee: Tatung Company, Taipei (TW)

(21) Appl. No.: 11/783,299

(22) Filed: Apr. 9, 2007

(30) Foreign Application Priority Data
Jul. 6, 2006 (TW) 095124642

(51) Int. Cl. H01M 4/58; C25D 7/00; B41M 5/20; H01M 4/04

(52) U.S. Cl. 429/221; 205/50; 252/182.1

(57) ABSTRACT

A method of preparing LiFePO₄/Li₃V₂(PO₄)₃ composite cathode materials and their applications as cathode materials for lithium ion batteries are disclosed. The preparation method includes the following steps: (A) providing a mixture of iron powder, lithium salt, vanadium salt, and a phosphate salt whereafter these compounds are dissolved into a mixed acid solution; (B) drying the solution in order to obtain precursor powders; and (C) heating the precursor powders at a temperature ranging between 400 and 1000° C. to form LiFe_{1-y′}V_{y′}PO₄/Li₃V_{2-y″}Fe_{y″}(PO₄)₃ composite powders. Alternatively, prepare the composite cathode by preparing olivine LiFe_{1-y′}V_{y′}PO₄ and monoclinic Li₃V_{2-y′}Fe_{y″}(PO₄)₃ powders as in previous procedures followed by mixing adequately. The low cost of iron powder thus facilitates to prepared composite cathode materials exhibiting higher electrical conductivity and superior cycling performance at high C rates than those of olivine LiFe_{1-y′}V_{y′}PO₄ and monoclinic Li₃V_{2-y″}Fe_{y″}(PO₄)₃. The invention will help the development of the lithium ion batteries and related industries.

### BACKGROUND OF THE INVENTION

1. Field of the Invention

The present invention relates about the composite cathode materials for lithium ion batteries, and that more particularly to indicate LiFePO₄/Li₃V₂(PO₄)₃ composite cathode materials for lithium ion batteries.

2. Description of Related Art

Because portable, wireless, and light-weighted consumer goods on the market have developed at a flourishing rate, demands for secondary batteries as the power supplies have accordingly increased. Currently, among small size secondary batteries, lithium-ion secondary batteries have especially met the requirements of high volume-specific capacity, environmental safety, and have been applied substantially to any kind of small portable 3C products. Furthermore, the high working voltage of lithium-ion batteries can lessen the problems of power management caused by series and/or parallel connection of batteries when they are used for high capacity and high power applications. It will become significant in the future. Despite considerable research, large size lithium-ion batteries for power and electrical storage applications are requested to be safer than small size lithium-ion batteries applied to 3C products, especially in thermal stability, tolerance of overcharge and over-discharge.

Cathode materials used in lithium-ion batteries are key points to decide the characteristics thereof. Among several accredited potential cathode materials, olivine structure LiFePO₄ cathode material has been recognized as a promising candidate because of its high theoretical capacity, environmental safety, high thermal stability, high tolerance of overcharge and over-discharge. Since the disclosure of U.S. Pat. No. 5,910,382 is published, LiFePO₄ cathode material has been more important.

Though olivine exists in the earth crust, the olivine structure LiFePO₄ used in cathode materials are artificial. Conventionally, olivine structure LiFePO₄ is synthesized from compounds with Fe³+or Fe²+, e.g. ferric sulfate, ferric nitrate, ferric acetate etc.. Because compounds with Fe²⁺ are too expensive, compounds with Fe²⁺ is generally obtained from reducing compounds with Fe³⁺. Traditionally, preparation of olivine structure LiFePO₄ is processed through solid-state reaction, wherein lithium salt, iron salt, and phosphate salt are grinded and mixed into powder, and then heated. The olivine structure LiFePO₄ cathode materials prepared by the solid-state reaction method are all single-phase materials. Because the solid-state reaction needs an excessively high temperature and long time let ions of precursors to diffuse, and the precursors would become the olivine structure LiFePO₄ powders. Because the prepared powders are synthetized by solid-state reaction, the prepared powders could grow about 50 μm diameters. The conventional synthesis methods and materials are shown in the published patents. However, the cathode materials of olivine structure LiFePO₄ have a big particle size to have bad conductivity. In order to solve the above problems, the precursors of carbon are generally added during the preparation or coated on the prepared powder surfaces to increase the surface electric conductivity of powders as mentioned in U.S. Pat. Nos. 6,528,033, 6,716,372, 6,730,281, and TW00513823; other metal ions are doped to improve migration of lithium ions in the material powders as mentioned in U.S. Pat. No. 6,514,640, 6,702,961, 6,716,372, 6,815,122, TW00522594, TW00525312, TW00523945, and TW00523952. Moreover, synthesized submicron powders with decreasing diffused distance of lithium ionsare used to increase conductivity and to promote cyclic-life at high C rate as mentioned in TW00535316, TW00589758, and CN1469499A. In CN1649188A, through electroless plating, the synthesized LiFePO₄ powders are plated with an interface layer of a tin compound, and then further plated with an assistant conduction layer of nickel or copper to increase the conductivity.

In U.S. Pat. No. 5,871,886, 6,528,033, 6,702,961, and TW00544967, Li₃V₂(PO₄)₃ cathode materials having charge/discharge characteristics prepared by solid-state reaction method are also proved, but are not as good as LiFePO₄ cathode materials. In TW00533617, LiFePO₄ mixed with another cathode material like LiCoO₂, LiNiO₂, LiMnO₄ etc. forms a composite cathode material. Batteries using the composite cathode material are compatible with lithium-ion batteries, and the energy density of the batteries using the composite cathode material is similar to that of lithium-ion batteries. In addition, the heat stability of operation and over-discharge resistibility of the batteries are improved, and the cost of the batteries is lower than conventional lithium-ion batteries. In the above-mentioned, LiFePO₄ with heat and over-discharge resistibility is utilized to a better extent than in the conventional cathode, but the working voltage thereof is lowered a little. SONY Company possesses patents TW00525312 and TW00522594 of other elements substituting for iron to form LiₓFe_{1-y}M_{y}PO₄ cathode materials. When index y ranges from 0 to 0.8, the powder synthesized through solid-state reaction is single phase of the olivine structure LiₓFe_{1-y}M_{y}PO₄ cathode material. When vanadium substitutes for iron, the LiₓFe_{0.25}V_{0.75}PO₄ cathode material is also olivine structure.

Further, in order to improve conductivity of LiFePO₄ cathode materials, the LiFePO₄/Li₃V₂(PO₄)₃ composite cathode materials are synthesized to form primary particles in submicron size by solution-based synthesis method; or the primary particles of LiFePO₄ and Li₃V₂(PO₄)₃ cathode materials in submicron size are synthesized individually through solution-based synthesis method, and mixed to form composite cathode materials. Furthermore, the LiFePO₄/Li₃V₂(PO₄)₃ composite cathode material prepared by the above two methods has increased conductivity so as to improve the high cyclic-life characteristic, and is a kind of lithium-ion batteries cathode material with non-aqueous electrolyte, which have been proven successful by tested coin type batteries. Because of adding the second material, the original voltage-specific capacity curve originally having only one plateau becomes having several increased plateaus with higher voltage, which prevents lithium-ion batteries from overcharging.

Therefore, it is desirable to provide a composite cathode material for lithium ion batteries, and, more particularly, to an LiFePO₄/Li₃V₂(PO₄)₃ composite cathode material for lithium ion batteries to mitigate and/or obviate the aforementioned problems.

### SUMMARY OF THE INVENTION

A main object of the present invention is to provide a composite cathode material, which includes at least an olivine and a monoclinic phase cathode material in order to increase the electrical conductivity thereof.

Another object of the present invention is to provide a composite cathode material, which improves high C-rate characteristics of the olivine composite cathode material and maintains high capacity of discharging when outputting high current.

Providing composite cathode materials for fabricating lithium ion batteries, which improves fast charge/discharge characteristic of batteries composed of the olivine composite cathode materials and maintains high capacity of discharging when outputting high current, is another object of the present invention.

There is another object in the present invention to provide a novel method for preparing LiFePO₄/Li₃V₂(PO₄)₃ composite cathode material, which can improve electrical conductivity of olivine composite cathode materials.

In order to achieve all foregoing objects, a method for preparing LiFePO₄/Li₃V₂(PO₄)₃ composite cathode materials in the present invention includes a solution-based synthesis method, which is a way of directly synthesizing primary particles in submicron size of LiFePO₄/Li₃V₂(PO₄)₃ composite cathode materials, or a way of individually synthesizing primary particle in submicron size of LiFePO₄ and Li₃V₂(PO₄)₃, and then mixing thereof to form a composite cathode material.

The direct solution-based synthesis method comprises the following steps: (A) with reference to LiₓFe_{1-y}V_{y}PO₄, wherein x is between 0.9 and 1.5, and y is between 0 and 1, providing a mixture of iron powder, vanadium, or vanadium compound in a dose ratio to dissolve them into a mixed acid solution (i.e. a mixed acid solution of organic acid and phosphoric acid) to process oxidation reaction; (B) stirring the mixed solution until the iron powder has reacted completely, and adding lithium salt into the mixed solution to form a precursor solution of LiFePO₄/Li₃V₂(PO₄)₃ composite cathode materials; (C) drying the precursor solution in order to obtain solid powders; and (D) heating the solid powders at temperature ranging from 400° C. to 1000° C. and maintaining the heating process.

In the present invention, the indirect solution-based synthesis method for preparing olivine composite cathode materials comprises the following steps: (A) synthesizing olivine phase LiFePO₄ and monoclinic phase Li₃V₂(PO₄)₃ cathode material powders; (B) mixing the olivine phase LiFePO₄ and monoclinic phase Li₃V₂(PO₄)₃ cathode material powders dispersed into an aqueous solution to form a mixed solution, wherein the molar ratio thereof is between 1:0.06 and 1:2; (C) drying the mixed solution or slurry to obtain solid powders; and (D) heating the solid powders at a temperature between 400 and 1000° C. The formation of olivine phase LiFePO₄ cathode material powders in the present invention is not limited to, but preferably involves mixing iron powder, lithium salt, and phosphate salt dissolved into a mixed acid solution to form a mixed precursor solution of LiFePO₄; subsequently stirring and then drying the mixed precursor solution/slurry to obtain precursor powders of LiFePO₄; and forming the precursor powders of LiFePO₄ through a heating process. In the mixed acid solution of the olivine phase LiFePO₄ cathode material, the molar ratio of the iron powder, the lithium salt, and the phosphate salt is preferred to be 0.9˜1.2: 0.9˜1.2: 0.9˜1.2. The formation of monoclinic phase Li₃V₂(PO₄)₃ cathode material powders in the present invention is not limited to, but preferably involves mixing vanadium salt, lithium salt, and phosphate salt dissolved into a mixed acid solution to form a mixed precursor solution/slurry of Li₃V₂(PO₄)₃; subsequently stirring and then drying the mixed precursor solution/slurry to obtain precursor powders of Li₃V₂(PO₄)₃; and forming the precursor powders of Li₃V₂(PO₄)₃ through a heating process. In the mixed acid solution of the monoclinic phase Li₃V₂(PO₄)₃ cathode material, the molar ratio of the lithium salt, the vanadium salt, and the phosphate salt is preferred to be 2.9˜3.2: 1.9˜2.2: 2.9˜3.2.

In the preparation of the present invention, the drying process of the step (C) can be any conventional drying process, but not limited to, preferably are directly drying or spray drying methods. In the preparation of LiFePO₄/Li₃V₂(PO₄)₃ composite cathode material, the step (D) can be a process to heat the solid powder in any conventional inert gas or inert/reduction mixture gas, but preferably is in nitrogen or argon gas. Additionally, the heating process is not limited, but is preferred to last 0.5 to 15 hours. In the preparation of the present invention, the mixed acid solution is a mixture of organic acid and inorganic acid. The organic acid of the mixed acid solution in the present invention is not limited to, but is preferable to be polyprotic acids of citric acid, oxalic acid, tartaric acid etc., or a mixture thereof. The inorganic acid of the mixed acid solution in the present invention is not limited to, but preferably is hydrochloric acid, sulfuric acid, nitric acid, phosphoric acid, perchloric acid, or a mixture thereof. The lithium salt of the mixed solution in the present invention is not limited to, but preferably is lithium hydrate, lithium fluoride, lithium nitrate, lithium chloride, lithium bromide, lithium acetate, lithium oxide, lithium phosphate, lithium hydrophosphate, lithium dihydrophosphate, lithium ammonium phosphate, lithium diammonium phosphate, or a mixture thereof. The vanadium salt in the present invention is not limited to, but is preferred to be VO₂, V₂O₃, V₂O₅, NH₄VO₃, or a mixture thereof. The phosphate salt of the mixed solution in the present invention is not limited to, but is preferred to be ammonium phosphate, diammonium hydrophosphate, ammonium dihydrophosphate, triammonium phosphate, phosphorus pentoxide, phosphoric acid, lithium hydrophosphate, lithium dihydrophosphate, lithium ammonium phosphate, lithium diammonium phosphate, or a mixture thereof. The step (A) of the mixed solution in the present invention further comprises selectively adding a carbohydrate or a polymer, which is heated at high temperature to supply a trace of carbon increasing electrical conductivity, and the content of the carbohydrate or the polymer is between 1 and 25 percent by weight of the total powders. The carbohydrate or polymer can be organic acid, sugar, polyester, polyvinyl alcohol, polyacrylic acid etc.

The LiFePO₄/Li₃V₂(PO₄)₃ composite cathode material in the present invention includes a compound of the following formula (I):

LiₓFe_{1-y}V_{y}(PO₄)_{z} formula (I)

In the formula (I), x is between 0.9 and 1.5, y is between 0 and 1, and z is between 0.9 and 1.5; and the cathode material has at least two crystalline phases of olivine phase LiFe_{1-y′}V_{y′}PO₄ and monoclinic phase Li₃V_{2-y″}Fe_{y″}(PO₄)₃. The content of the two olivine LiFe_{1-y′}V_{y′}PO₄ and monoclinic Li₃V_{2-y″}Fe_{y″}(PO₄), is controlled by adjusting the initial elemental ratio of Fe, V and Li in the step (A) and (B). Finally, the composite cathode material with evenly distributed crystalline phases is achieved.

A battery of the present invention comprises: an anode, a cathode, and a non-aqueous electrolyte, which is formed between the anode and the cathode. The cathode comprises a composite cathode material of the formula (I), and the cathode material at least has two evenly distributed crystalline phases.

The LiFePO₄/Li₃V₂(PO₄)₃ composite cathode material in the present invention has improved electrical conductivity, which preferably is more than 10⁻² Scm⁻¹. The voltage-specific capacity curve of the LiFePO₄/Li₃V₂(PO₄)₃ composite cathode material can be any curve, but is preferred to have a charge/discharge plateau of olivine phase LiFePO₄ and monoclinic phase Li₃V₂(PO₄)₃ simultaneously. The olivine and monoclinic composite cathode material in the present invention can be made by mixing powders of LiFePO₄ and Li₃V₂(PO₄)₃ synthesized through using the foregoing methods.

Other objects, advantages, and novel features of the invention will become more apparent from the following detailed description when taken in conjunction with the accompanying drawings.

### BRIEF DESCRIPTION OF THE DRAWINGS

FIG. 1 is an X-ray diffraction pattern of the embodiment 1 in the present invention;

FIG. 2 is an SEM and mapping micrograph of the embodiment 1 in the present invention;

FIG. 3 is a cyclic charge/discharge diagram of the embodiment 1 in the present invention;

FIG. 4 is a cyclic charge/discharge curve of the embodiment 1 in the present invention; and

FIG. 5 is a comparative diagram of cyclic charge/discharge results of the embodiment 2 in the present invention.

### DETAILED DESCRIPTION OF THE PREFERRED EMBODIMENT

### Embodiment 1

### To Prepare Olivine Phase LiFe_{1-y′}V_{y′}PO₄ and Monoclinic Phase Li₃V_{2-y″}Fe_{y″}(PO₄)₃ Composite Cathode Material Powders by Direct Solution-based Methods and Spray Drying Methods

0.5 mole iron powders, 0.5 mole NH₄VO₃ powders, 1 mole LiOH powders, and 400 mL 0.5 mole citric acid solution are added in 1 mole (NH₄)₂HPO₄ solution. In the mixed solution, the molar ratio of Li⁺, Fe²⁺, V³⁺, and PO₄³⁻ is 1: 0.5: 0.5: 1. Subsequently, 4.7 g PEG dissolved in optimal water, which becomes 3 wt % PEG solution, is added into the mixed solution. After reacting iron powders, LiOH, NH₄VO₃, citric acid, and (NH₄)₂HPO₄ solution completely, this solution is dried by a spray drying method to obtain precursor powders of LiFe_{1-y′}V_{y′}PO₄/Li₃V_{2-y″}Fe_{y″}(PO₄)₃ composite cathode material. The LiFe_{1-y′}V_{y′}PO₄/Li₃V_{2-y″}Fe_{y}″(PO₄)₃ composite cathode material precursor powders are put into nitrogen gas and then heated at 750° C. for 6 hours, whereafter 282 g of the LiFe_{1-y′}V_{y′}PO₄/Li₃V_{2-y″}Fe_{y″}(PO₄)₃ composite cathode material powders is obtained.

### Testing Results

a. X-ray diffraction analysis

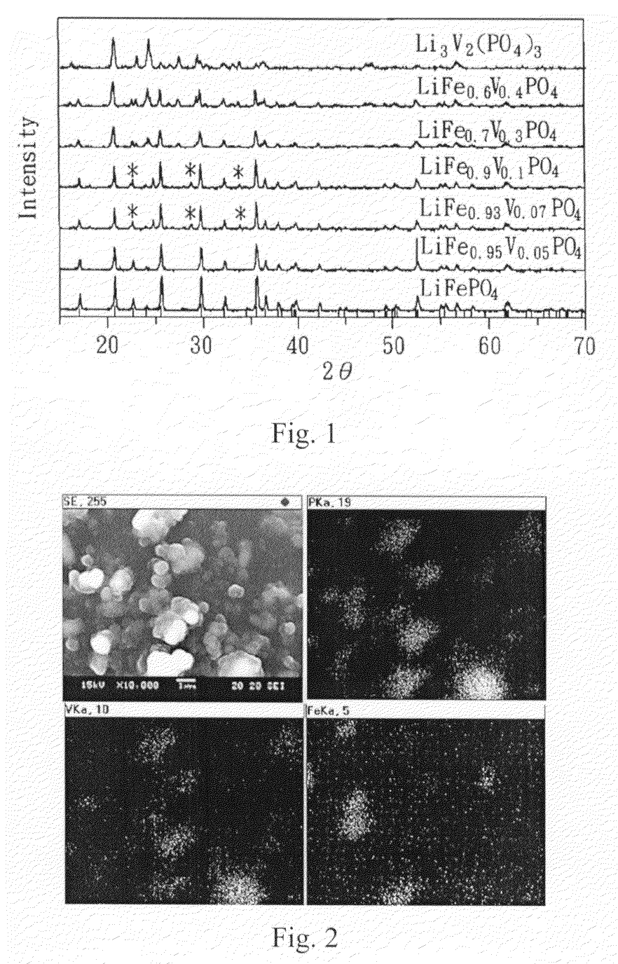

As shown in FIG. 1, the X-ray diffraction patterns of the prepared LiFePO₄/Li₃V₂(PO₄)₃ composite cathode material powders with LiFe_{1-y′}V_{y′}PO₄/Li₃V_{2-y″}Fe_{y″}(PO₄)₃ in this embodiment mainly show two signal peaks of olivine LiFePO₄ and monoclinic Li₃V₂(PO₄)₃, and the more V added means the more distinct peak signals (i.e. peaks with *).

According to the preparation of LiFe_{1-y′}V_{y′}PO₄/Li₃V_{2-y″}Fe_{y″}(PO₄)₃ composite cathode material powders in the present invention, as long as exact ratio mixture of iron powders, lithium salt, vanadium salt, and ammonium phosphate salt is reacted in a mixed acid solution, LiFe_{1-y′}V_{y′}PO₄/Li₃V_{2-y″}Fe_{y″}(PO₄)₃ composite cathode material powders would be prepared by any conventional method of drying and heating.

b. SEM and mapping analysis

As the SEM and mapping micrographs shown in FIG. 2, the primary particle diameter of the LiFe_{1-y′}V_{y′}PO₄/Li₃V_{2-y″}Fe_{y″}(PO₄)₃ composite cathode material powders prepared by the spray drying method in this embodiment is about 1˜2 μm. Any elemental distribution of the composite cathode material powders after adding various dosages of vanadium is observed through mapping. As shown in elemental distribution plots when the added dosage x of vanadium is 0.5, the olivine phase LiFePO₄ and monoclinic phase Li₃V₂(PO₄)₃ exist together in the mixed powders.

c. Electrical conductivity analysis of powders detected by conductivity measurement system

Compared data of electrical conductivity of powders analyzed by conductivity measurement system are shown in table 1. Among single phase LiFePO₄ prepared by a solid-state reaction method, and LiFePO₄ (i.e. LFP), Li₃V₂(PO₄)₃ (i.e. LVP), and LiFePO₄/Li₃V₂(PO₄)₃ composite (i.e. LFVP) prepared in this embodiment, the LFVP has improved electrical conductivity in the similar carbon content and particle diameter.

TABLE 1
comparing electrical conductivity of LiFePO₄, Li₃V₂(PO₄)₃,
and LiFePO₄/Li₃V₂(PO₄)₃ cathode materials

| | content of | | electrical conductivity |
|---|---|---|---|
| sample | carbon (wt %) | D₅₀ (μm) | (Scm⁻¹) |
| single phase | — | 8.44 | 3.63 × 10⁻⁸ |
| LiFePO₄ | | | |
| LFP | 3.31 | 3.769 | 6.75 × 10⁻³ |
| LVP | 3.18 | 4.037 | 2.88 × 10⁻⁴ |
| LFVP | 3.52 | 3.123 | 2.5 × 10⁻² |

d. Tests of cyclic voltammetry

The prepared LiFePO₄/Li₃V₂(PO₄)₃ composite cathode material, acetylene black, and polyvinylidene fluoride (PVDF) mixed at ratio of 83: 10: 7 by weight are mixed with N-methylpyrollidone (NMP) to become a slurry spread evenly on aluminum foil. The slurry is prepared to form a suitable cathode test slice through drying. In glove box filled with argon gas, lithium foil used as a counter and reference electrode, 1 M LiPF₆ in EC/DEC (1:1 vol.) used as electrolyte, and Celgard 2400 used as separation membrane are set into a tri-electrode battery in which cyclic voltammetry processes occur. The result of cyclic voltammetry shows that redox reactions of olivine phase LiFePO₄ and monoclinic phase Li₃V₂(PO₄)₃ happen in the LiFePO₄/Li₃V₂(PO₄)₃ composite cathode material (i.e. the redox feature peaks of LiFePO₄ are 3.35 V reductive peaks and 3.5 V oxidative peaks; the redox feature peaks of Li₃V₂(PO₄)₃ are redox peak pairs of reductive peaks of 3.56 V vs. oxidative peaks of 3.6 V, reductive peaks of 3.64 V vs. oxidative peaks of 3.7 V, and reductive peaks of 4.02 V vs. oxidative peaks of 4.11 V.). According to these tests, the cathode material in the present invention is a composite of LiFePO₄/Li₃V₂(PO₄)₃, and different from conventional LiFePO₄ cathode materials. Additionally, the LiFePO₄/Li₃V₂(PO₄)₃ composite cathode material in the present invention tested by cyclic voltammetry has an improved working voltage of LiFePO₄ due to redox reaction of Li₃V₂(PO₄)₃ therein.

e. Tests of cyclic charge/discharge

The LiFePO₄/Li₃V₂(PO₄)₃ composite cathode material prepared in this embodiment, acetylene black, and polyvinylidene fluoride (PVDF) mixed at ratio of 83: 10: 7 by weight are mixed with N-methylpyrollidone (NMP) to become a slurry spread evenly on aluminum foil. The slurry is prepared to form a suitable cathode test slice through drying. In a glove box filled with argon gas, lithium foil used as negative electrode, 1 M LiPF₆ in EC/DEC (1:1 vol.) used as electrolyte, and Celgard 2400 used as separation membrane are set into a coin battery for cyclic charge/discharge tests to be processed therein.

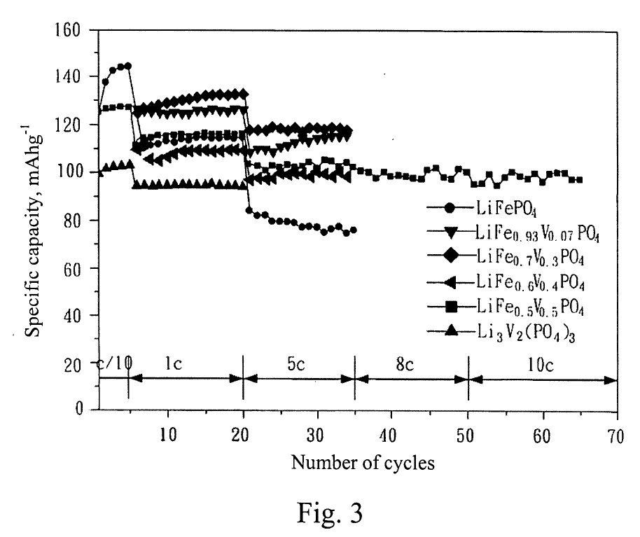

As per the cyclic charge/discharge tests in this embodiment shown in FIG. 3, the results of charge/discharge tests are shown at various charge/discharge rates (between C/10 and 10C) in cutoff voltages ranging from 2.5 V to 4.3 V. FIG. 3 shows that specific capacity of the coin battery made of the LiFePO₄/Li₃V₂(PO₄)₃ composite cathode material prepared in the embodiment 1 is between specific capacity of olivine phase LiFePO₄ and monoclinic phase Li₃V₂(PO₄)₃ in conditions of room temperature and C/10 charge/discharge rate (0.06 mA/cm²), and initial specific capacity thereof is maintained at 127 mAh/g even though 5 charge/discharge cycles have elapsed. When the olivine LiFePO₄/Li₃V₂(PO₄)₃ composite cathode material powders in this embodiment are used as cathode materials, the capacity thereofis not faded, but it still has good charge/discharge characteristics at slower charge/discharge rate of C/10. Further, when testing at faster charge/discharge rates (1C, 5C, 8C, and 10C), the results thereof demonstrate that the battery made of powders synthesized in this embodiment still have good charge/discharge characteristics. The initial specific capacity of the battery so far is 110 mAh/g at fast charge/discharge rate of 1C, and 105 mAh/g at faster charge/discharge rate of 5C, even though 15 charge/discharge cycles have elapsed. In the figures, all of the composite cathode material comparing to olivine LiFePO₄ or monoclinic Li₃V₂(PO₄)₃ cathode material with similar carbon content synthesized according to the same method of the present invention have higher specific capacity. At charge/discharge rates of 8C and 10C, the battery made of the olivine LiFePO₄/Li₃V₂(PO₄)₃ composite cathode material powders in this embodiment still maintain discharge capacity of 100 mAh/g almost without any capacity fading.

f. Tests of batteries charge/discharge curve

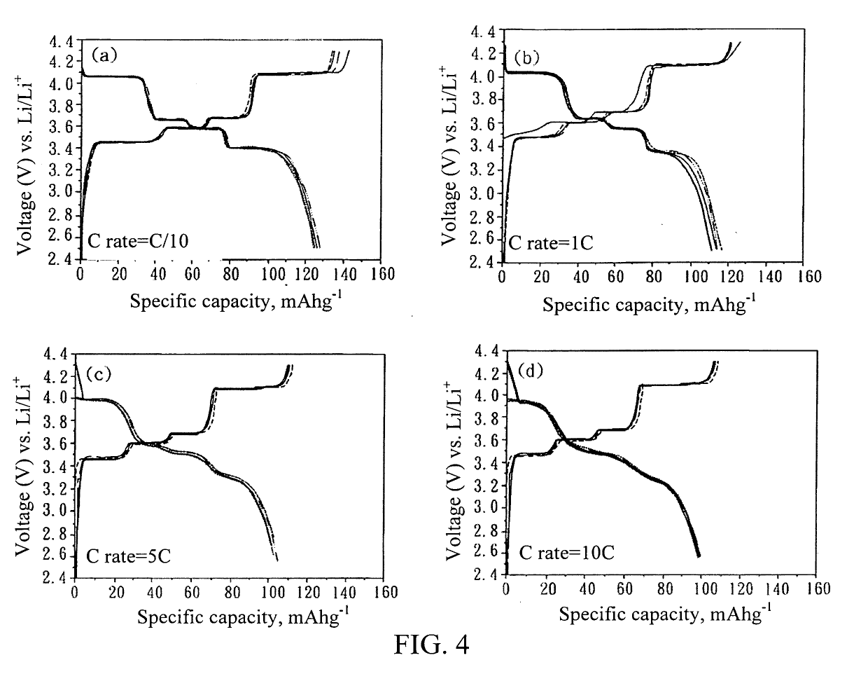

Tests of cyclic charge/discharge at various rate processes in the coin battery prepared similarly through the method of mentioned “tests of cyclic charge/discharge”, and the results are plotted into a voltage-specific capacity curve (see FIG. 4). The voltage-specific capacity curve of LiFePO₄/Li₃V₂(PO₄)₃ composite cathode material at different charge/discharge rates is a curve with plural plateaus. In addition to plural plateaus improving working voltage of olivine composite cathode materials, those are also applied to calculate the residual electrical quantity of batteries and to prevent overcharge of lithium batteries.

### Embodiment 2

### Individually Preparing Olivine Phase LiFePO₄ and Monoclinic Phase Li₃V₂(PO₄)₃ Cathode Material by Way of Indirect Solution-based Methods and Mixing These to Obtain the LiFePO₄/Li₃V₂(PO₄)₃ Composite Cathode Material

5 mole iron powders, 5 mole LiOH, 5 mole (NH₄)₂HPO₄, and 1700 mL 4 mole citric acid solution are mixed to form a solution. In the mixed solution, the molar ratio of Li⁺, Fe²⁺, and PO₄³⁻ is 1: 1: 1. Subsequently, 23.66 g PEG dissolved in optimal water, which becomes 3 wt % PEG solution, is added into the mixed solution. After reacting iron powders, LiOH, citric acid, and (NH₄)₂HPO₄ completely, this solution is dried by a spray drying method to obtain precursor powders of pure phase LiFePO₄. The olivine LiFePO₄ cathode material precursor powders put into nitrogen gas are heated at 750° C. for 6 hours, and then 800 g of the olivine phase LiFePO₄ cathode material powders is obtained.

1 mole NH₄VO₃, 1.5 mole LiOH, 1.5 mole (NH₄)₂HPO₄, and 170 mL 1.5 mole citric acid solution are mixed to form a solution. In the mixed solution, the molar ratio of Li⁺, V³⁺, and PO₄³⁻ is 3: 2: 3. Subsequently, 6.11 g PEG dissolved in optimal water, which becomes a 3 wt % PEG solution, is added into the mixed solution. After reacting NH₄VO₃, LiOH, citric acid, and (NH₄)₂HPO₄ completely, this solution is dried by the spray drying method to obtain precursor powders of pure phase Li₃V₂(PO₄)₃. The Li₃V₂(PO₄)₃ cathode material precursor powders are then put into nitrogen gas and heated at 750° C. for 6 hours, after which 200 g of the monoclinic phase Li₃V₂(PO₄)₃ cathode material powders is obtained.

Further, in the aforementioned preparation, 800 g of the olivine LiFePO₄ and 200 g of the monoclinic Li₃V₂(PO₄)₃ and cathode material powders are mixed together. In the mixed powders, the molar ratio of LiFePO₄ and Li₃V₂(PO₄)₃ is 5: 0.5. After adding the mixed powders into the 3 wt % PEG solution, the mixed solution is dried by the spray drying method to obtain composite cathode material precursor powders with even distribution of olivine LiFePO₄ and monoclinic Li₃V₂(PO₄)₃. The powders obtained by the spray drying method are put into nitrogen gas and heated at 750° C. for 1 hours, after which 1000 g LiFePO₄/Li₃V₂(PO₄)₃ composite cathode material powders is obtained.

### Testing Results

### Tests of cyclic charge/discharge

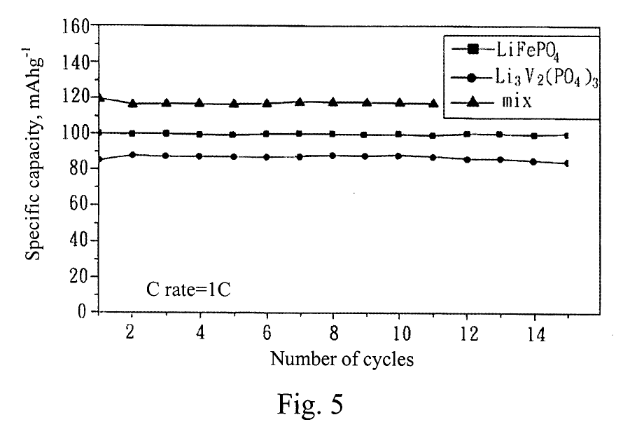

The three kinds of powders prepared in the embodiment 2, acetylene black, and polyvinylidene fluoride (PVDF) mixed at ratio of 83: 10: 7 by weight are mixed with N-methylpyrollidone (NMP) to become aslurry spread evenly on aluminum foil. The slurry is prepared to form a suitable cathode test slice through drying. The lithium foil used as negative electrode, 1 M LiPF₆ in EC/DEC (1:1 vol.) used as electrolyte, and Celgard 2400 used as separation membrane are set into a coin battery in which cyclic charge/discharge tests are processed. As per the results shown in FIG. 5, the discharge capacity of the LiFePO₄/Li₃V₂(PO₄)₃ composite cathode material powders is higher than the discharge capacity of pure olivine LiFePO₄ and monoclinic Li₃V₂(PO₄)₃ cathode material powders prepared in the embodiment 2

The LiFePO₄/Li₃V₂(PO₄)₃ composite cathode material powders prepared in the present invention have higher electric conductivity than olivine and monoclinic phase cathode material powders to improve high charge/discharge rate in the lithium batteries, and are suitably applied in the present lithium batteries. Further, the material with composite microstructure prepared in the present invention is a novel material dramatically differing from, and better than, conventional LiFePO₄ material.

Although the present invention has been explained in relation to its preferred embodiment, it is to be understood that many other possible modifications and variations can be made without departing from the scope of the invention as hereinafter claimed.

What is claimed is:

1. A method for preparing LiFePO₄/Li₃V₂(PO₄)₃ composite cathode materials comprising the following steps:
(A) providing a mixture of iron powder, lithium salt, vanadium salt, and phosphate salt dissolved into a mixed acid solution to form a mixed solution of LiₓFe_{1-y}V_{y}(PO₄)_{z}, wherein x is between 0.9 and 1.5, y is between 0 and 1, and z is between 0.9 and 1.5;
(B) stirring the mixed solution;
(C) drying the mixed solution in order to obtain solid powders; and
(D) heating the solid powders at temperature ranging between 400° C. and 1000° C.

2. The method as claimed in claim 1, wherein the step (C) is a conventional method for directly heat drying or spray drying the mixed solution.

3. The method as claimed in claim 1, wherein the step (D) is a heating process of the solid powder in nitrogen or argon gas.

4. The method as claimed in claim 1, wherein the mixed acid solution is a mixture of organic acid and inorganic acid.

5. The method as claimed in claim 4, wherein the organic acid is acetic acid, citric acid, oxalic acid, tartaric acid, propionic acid, butyric acid, or a mixture thereof; the inorganic acids are hydrochloric acid, sulfuric acid, nitric acid, perchloric acid, hypochlorous acid, hydrofluoric acid, or a mixture thereof.

6. The method as claimed in claim 1, wherein the step (A) further comprises adding a carbohydrate or a polymer, which is heated at high temperature to supply a trace of carbon increasing electrical conductivity, and the content of the carbohydrate or the polymer is between 1 and 25 percent by weight of the total powders.

7. The method as claimed in claim 1, wherein the duration of the heating process in the step (D) is from 1 to 15 hours.

8. The method as claimed in claim 1, wherein the lithium salt is lithium hydrate, lithium fluoride, lithium nitrate, lithium chloride, lithium bromide, lithium acetate, lithium oxide, lithium phosphate, lithium hydrophosphate, lithium dihydrophosphate, lithium ammonium phosphate, lithium diammonium phosphate, or a mixture thereof.

9. The method as claimed in claim 1, wherein the phosphate salt is diammonium hydrophosphate, ammonium dihydrophosphate, triammonium phosphate, phosphorus pentoxide, phosphoric acid, lithium hydrophosphate, lithium dihydrophosphate, lithium ammonium phosphate, lithium diammonium phosphate, or a mixture thereof.

10. The method as claimed in claim 1, wherein the vanadium salt is VO₂, V₂O₃, V₂O₅, NH₄VO₃, or a mixture thereof.

11. The method as claimed in claim 1, wherein the heating process means heating the solid powders at a temperature between 400° C. and 1000° C.

12. A method for preparing LiFePO₄/Li₃V₂(PO₄)₃ composite cathode materials comprising the following steps:
(A) providing olivine phase LiFePO₄ and monoclinic phase Li₃V₂(PO₄)₃ cathode materials;
(B) mixing the olivine phase LiFePO₄ and monoclinic phase Li₃V₂(PO₄)₃ cathode materials dispersed into an aqueous solution to form a mixed solution or slurry, wherein the molar ratio thereof is between 1:0.06 and 1:2;
(C) drying the mixed solution or slurry to obtain solid powders; and
(D) heating the solid powders at a temperature between 400 and 1000° C.

13. The method as claimed in claim 12, wherein the formation of the olivine phase LiFePO₄ cathode material powders comprises: mixing iron powder, lithium salt, and phosphate salt dissolved into a mixed acid solution to form a mixed precursor solution of LiFePO₄; subsequently stirring the mixed precursor solution, and drying the mixed precursor solution to obtain precursor powders of LiFePO₄; and forming the precursor powders of LiFePO₄ through a heating process.

14. The method as claimed in claim 12, wherein the formation of the monoclinic phase Li₃V₂(PO₄)₃ cathode material powders comprises: mixing vanadium salt, lithium salt, and phosphate salt dissolved into a mixed acid solution to form a mixed precursor solution of Li₃V₂(PO₄)₃; subsequently stirring the mixed precursor solution, and drying the mixed precursor solution to obtain precursor powders of Li₃V₂(PO₄)₃; and forming the precursor powders of Li₃V₂(PO₄)₃ through a heating process.

15. The method as claimed in claim 13, wherein the molar ratio of the iron powder, the lithium salt, and the phosphate salt dissolved into the mixed acid solution is 0.9˜1.2: 0.9˜1.2: 0.9˜1.2.

16. The method as claimed in claim 13 or 14, wherein the mixed acid solution is organic acid, or inorganic acid, or a mixture thereof.

17. The method as claimed in claim 16, wherein the organic acid is acetic acid, citric acid, oxalic acid, tartaric acid, propionic acid, butyric acid, or a mixture thereof; the inorganic acids are hydrochloric acid, sulfuric acid, nitric acid, perchloric acid, hypochlorous acid, hydrofluoric acid, or a mixture thereof.

18. The method as claimed in claim 13 or 14, wherein the mixed precursor solution has further added thereto a carbohydrate or a polymer, and the content of the carbohydrate or the polymer is between 1 and 25 percent by weight of the total powders.

19. The method as claimed in claim 13 or 14, wherein the lithium salt is lithium hydrate, lithium fluoride, lithium nitrate, lithium chloride, lithium bromide, lithium acetate, lithium oxide, lithium phosphate, lithium hydrophosphate, lithium dihydrophosphate, lithium ammonium phosphate, lithium diammonium phosphate, or a mixture thereof.

20. The method as claimed in claim 13 or 14, wherein the phosphate salt is diammonium hydrophosphate, ammonium dihydrophosphate, triammonium phosphate, phosphorus pentoxide, phosphoric acid, lithium hydrophosphate, lithium dihydrophosphate, lithium ammonium phosphate, lithium diammonium phosphate, or a mixture thereof.

21. The method as claimed in claim 14, wherein the molar ratio of the lithium salt, the vanadium salt, and the phosphate salt dissolved into the mixed acid solution is 2.9˜3.2: 1.9˜2.2: 2.9˜3.2.

22. The method as claimed in claim 14, wherein the vanadium salt is VO₂, V₂O₃, V₂O₅, NH₄VO₃, or a mixture thereof.

23. The method as claimed in claim 13 or 14, wherein the heating process means heating the solid powders at a temperature between 400° C. and 1000° C.

24. A composite cathode material comprising a compound of the following formula (I):
LiₓFe_{1-y}V_{y}(PO₄)z formula (I);
wherein x is between 0.9 and 1.5, y is between 0 and 1, and z is between 0.9 and 1.5; and the cathode material at least has two evenly distributed crystalline phases.

25. The composite cathode material as claimed in claim 24, wherein the two crystalline phases of the cathode material are respectively olivine phase LiFePO₄ and monoclinic phase Li₃V₂(PO₄)₃.

26. The composite cathode material as claimed in claim 24, wherein the electrical conductivity of the olivine composite cathode material is more than 10⁻² Scm⁻¹.

27. The composite cathode material as claimed in claim 24, wherein the composite cathode material in the voltage-specific capacity curve has plural plateaus.

28. A battery comprising:
an anode;
a cathode; and
a non-aqueous electrolyte which is formed between the anode and the cathode, wherein the cathode comprises a composite cathode material of the following formula (I):
LiₓFe_{1-y}V_{y}(PO₄)_{z}, formula (I);
wherein x is between 0.9 and 1.5, y is between 0 and 1, and z is between 0.9 and 1.5; and the cathode material at least has two evenly distributed crystalline phases.

29. The battery as claimed in claim 28, wherein the two crystalline phases of the cathode material are respectively, olivine LiFePO₄ and monoclinic Li₃V₂(PO₄)₃.

30. The battery as claimed in claim 28, wherein the olivine composite cathode material in the voltage-specific capacity curve has plural plateaus.
